(19) United States
(12) Patent Application Publication
(10) Pub. No.: US 2025/0283997 A1
(43) Pub. Date: Sep. 11, 2025

(54) Method for Operating a Measuring Device

(71) Applicant: Robert Bosch GmbH, Stuttgart (DE)

(72) Inventors: Andreas Koelsch, Peiting (DE); Andreas Frischen, Leonberg (DE); Anke Giliard, Stuttgart (DE); Benjamin Moster, Niefern-Oeschelbronn (DE); Heiko Sgarz, Leonberg (DE); Jan Linus Steuler, Woelfersheim (DE); Jonas Messner, Stuttgart (DE); Juergen Winterhalter, Stuttgart (DE); Kakit Law, Reutlingen (DE); Lukas Fiederer, Balingen (DE); Michael Brand, Berlin (DE); Sachin Lingadahalli Vittal, Viernheim (DE); Stephan Krane, Woerth Am Rhein (DE); Uwe Troeltzsch, Roesrath (DE)

(21) Appl. No.: 19/071,230

(22) Filed: Mar. 5, 2025

(30) Foreign Application Priority Data
Mar. 11, 2024 (DE) 10 2024 202 238.1

(51) Int. Cl. G01S 13/88; G01S 7/41; G01S 13/86

(52) U.S. Cl. CPC G01S 13/888; G01S 7/412; G01S 13/86

(57) ABSTRACT

A computer-implemented method for operating a measuring device, in particular a wall diagnostic device, includes receiving radar data of a radar sensor unit of the measuring device, the radar data depicting a wall to be diagnosed, and performing wall diagnostics by performing an analysis of the radar data and providing diagnostic results with a diagnostic module of the measuring device. The wall diagnostics includes performing an object recognition of an object disposed in the wall using the diagnostic module, the object recognition including object detection and object classification. The wall diagnostics further includes providing the diagnostic results from the diagnostic module to a display unit of the measuring device for displaying the diagnostic results to a user of the measuring device, wherein the diagnostic results include at least one object position in the wall and an object type of the object.

This application claims priority under 35 U.S.C. § 119 to application no. DE 10 2024 202 238.1, filed on Mar. 11, 2024 in Germany, the disclosure of which is incorporated herein by reference in its entirety.

The present disclosure relates to a method for operating a measuring device, in particular a wall diagnostic device.

### BACKGROUND

Diagnostic devices for diagnosing walls and detecting objects formed in the walls are known in the prior art.

It is an object of the present disclosure to provide an improved method of operating a

measuring device, in particular a wall diagnostic device.

### SUMMARY

According to one aspect, a computer-implemented method of operating a measuring device, in particular a wall diagnostic device is provided, comprising:
receiving radar data from a radar sensor unit of the measuring device, wherein the radar data depicts a wall to be diagnosed;
performing a wall diagnostics by performing an analysis of the radar data and providing diagnostic results via a diagnostic module of the measuring device, wherein the wall diagnostic comprises:
   performing an object recognition of an object disposed in the wall using the diagnostic module, wherein the object recognition comprises an object detection and an object classification; and
   providing the diagnostic results of the diagnostic module to a display unit of the measuring device for displaying the diagnostic results to a user of the measuring device, wherein the diagnostic results comprise at least one object position in the wall and an object type of the object.

The technical advantage can thereby be achieved that an improved method for operating a measuring device, in particular a wall diagnostic device, can be provided. For this purpose, wall diagnostics are performed by a diagnostic module based on radar data from at least one radar sensor unit of the measuring device depicting a wall to be diagnosed. For this purpose, the wall diagnostics comprises an object recognition of at least one object disposed in the wall using the diagnostic module.

The object recognition comprises an object detection and object classification. Object detection comprises determining an object's position within the wall, and object classification comprises determining the type of object located in the wall. The diagnostic results of the wall diagnostics, including at least the object's position and type, are further displayed in a display unit of the measuring device. The correspondingly designed diagnostic module can perform the wall diagnostics, including the object recognition described above, based solely on radar data from the radar sensor unit.

By configuring the diagnostic module for the corresponding object recognition, including object detection and object classification, based solely on radar data, it is possible to avoid considering additional sensor information from additional sensors for the object recognition. As a result, the measuring device can be designed more efficiently by eliminating the need for additional sensors besides the radar sensor unit.

According to one embodiment, the wall diagnostics further comprises:

performing a wall type classification and determining a wall type of the wall by the diagnostic module.

This can achieve the technical advantage that, in addition to object recognition, wall type classification can also be performed based solely on the radar data from the radar sensor unit. In the wall type classification, various wall types of the walls to be examined can be determined or classified by the correspondingly configured diagnostic module. Because the wall type is classified automatically, the user does not have to enter the respective wall type of the wall to be examined as additional information for the wall diagnostics, as is known from the prior art. Instead, the wall type is automatically determined by the diagnostic module based on the radar data from the radar sensor unit.

The wall type may be incorporated into the wall diagnostics and object recognition as additional information, for example for background correction. Alternatively or additionally, the detected wall type may be displayed to the user in the display unit as additional information in the diagnostic result.

According to one embodiment, the wall diagnostics further comprises:
performing an object depth determination using the diagnostic module and determining an object depth of the object in the wall, wherein the object depth is defined as a distance of the object to a surface of the wall.

The technical advantage can thereby be achieved that, based on the radar data of the radar sensor unit, an object depth of the object within the wall can be determined by the measuring device in addition to the object recognition. The object depth describes a distance of the object to a surface of the wall. The correspondingly configured diagnostic module may determine the object depth based solely on the radar data of the radar sensor unit.

According to one embodiment, the analysis of the radar data further comprises:
performing an object extension determination and determining an object extension of the object along a predefined direction via the diagnostics module.

The technical advantage can thereby be achieved that an object extension of the object detected in the wall is further enabled based on the radar data of the radar sensor unit. The object extension describes an extension of the object at least with respect to one spatial direction, preferably with respect to two spatial directions, especially preferably with respect to three spatial directions. This allows for a one-dimensional, preferably two-dimensional, more preferably three-dimensional extension information for the object located in the wall.

According to one embodiment, the wall diagnostics further comprises:
performing a pre-processing of radar data of the radar sensor unit and providing input data to a wall type classification module of the diagnostic module using a first pre-processing module;
performing the wall type classification based on the input data provided by the first pre-processing module and providing wall type information using a wall type classification module of the diagnostic module;
performing a pre-processing of the radar data and providing input data to an object recognition module of the diagnostic module in consideration of the wall type information using a second pre-processing module of the diagnostic module;
performing an object recognition based on the input data provided by the second pre-processing module and providing diagnostic results using the object recognition module.

The technical advantage can thereby be achieved that precise wall diagnostics are enabled by the correspondingly configured diagnostic module using the radar data of the radar sensor unit.

By pre-processing the radar data of the radar sensor unit, the radar data can be brought into the form required for the wall diagnostics. Using a correspondingly configured wall type classification module, a corresponding wall type classification can be performed on the pre-processed radar data and the respective wall type of the wall can be determined.

An object recognition of an object disposed in a wall may be performed by an object recognition module based on the pre-processed radar data and taking into account the wall type provided by the wall type classification module. The object recognition module is configured to perform an object detection and object classification of the object disposed in the wall based on the pre-processed radar data and taking into account the provided wall type. The presented architecture of the diagnostic module allows for the most precise and reliable wall diagnostics for walls to be examined.

According to one embodiment, radar data is received for a plurality of positions of the measuring device relative to the wall, wherein the method further comprises:
receiving movement data of a movement detection unit of the measuring device, wherein the movement data represents a movement of the measuring device relative to the wall between the plurality of positions of the measuring device relative to the wall.

This can achieve the technical advantage that, by considering movement data from a movement detection unit, wall diagnostics can be performed for various positions of the measuring device relative to the wall. The movement data here depicts the movement of the measuring device between a plurality of positions of the measuring device relative to the wall. Considering the movement data thus allows for accurate positioning or position determination of the measuring device relative to the wall. Based on this, the wall diagnostics can be performed in a position-dependent manner for the various positions of the measuring device relative to the wall.

Furthermore, the movement of the measuring device between the various positions relative to the wall can be realized based on the movement data. This enables the wall diagnostics to be carried out while the measuring device is moving relative to the wall, enabling the wall diagnosis to examine a larger area of the wall than would be possible by the effective range of the radar sensor unit alone. This accelerates the wall diagnostics and allows for a more precise examination of a contiguous area of the wall to be examined.

According to one embodiment, the method furthermore comprises:
checking, based on the movement data of the movement detection unit, whether a movement of the measuring device relative to the wall by a predefined distance has been detected;
if no movement has been detected, storing the radar data and performing the check once again;
If movement by the predefined distance has been detected, performing the wall diagnostics based on the radar data using the diagnostic module.

This can achieve the technical advantage that the wall diagnosis is performed at predetermined intervals while the measuring device is moving relative to the wall. The wall diagnostics are performed on the radar data captured by the measuring device during the movement relative to the wall over the predefined distance. The wall to be examined can thus be scanned by the measuring device within the wall diagnostics according to the predefined distance. This enables a precise wall diagnostics of an extended area of the wall to be examined.

According to one embodiment, the wall diagnostics further comprises:
summarizing sub-objects detected and classified to a contiguous object based on radar data received at different positions of the measuring device relative to the wall, if there is a predefined distance dependency between the sub-objects.

In this way, the technical advantage can be achieved that by summarizing the sub-objects detected and classified relative to the wall in the various positions of the measuring device based on the radar data into a contiguous object, a precise wall diagnostics is possible, including a precise object recognition. While moving the measuring device relative to the wall, the wall diagnostics are performed according to the embodiments described above.

For the movement segments defined according to the predefined distances, the partial results, i.e. partial objects of the object to be detected within the wall, are determined by the diagnostic module during the wall diagnostics. The classified partial objects here describe portions of an extended object that is depicted by movement of the measuring device relative to the wall in portions of the movement. By summarizing the correspondingly classified partial objects into an overall object, the extended object can be described and detected in detail. This allows for precise wall diagnostics and detection of extended objects.

According to one embodiment, the measuring device further comprises at least one of an induction sensor and/or an eddy current sensor and/or a capacitance sensor and/or an AC current sensor and/or a nuclear magnetic resonance (NMR) sensor and/or an ultrasonic sensor for providing additional sensor data, wherein the diagnostic module is configured to perform the wall diagnostics by taking into account the additional sensor data.

The technical advantage can thereby be achieved that, through further sensor data, additional sensors, each of which is configured to detect different physical variables, can provide additional information in addition to the radar data of the radar sensor unit, for incorporation into the wall diagnostics. This additional information, which is preferably complementary to the information of the radar data of the radar sensor unit, allows further precise specification of the wall diagnostics or the object recognition.

According to one embodiment, the diagnostic module comprises at least one correspondingly trained artificial intelligence configured to perform an object recognition and/or wall classification and/or object depth determination based on the radar data and/or the additional sensor data.

The technical advantage can thereby be achieved that, because the diagnostic module is formed as a correspondingly trained artificial intelligence, that is trained based on the radar data, or, if applicable, taking into account the information of the additional sensors, to perform an object recognition and/or a wall classification and/or an object depth determination and/or an object extension determination, a reliable and powerful diagnostic module can be provided. By using the artificial intelligence technique, precise wall diagnostics can be provided.

Provided according to one aspect is a computing unit configured to perform the method of operating a measuring device according to one of the preceding embodiments.

Provided according to one aspect is a computer program product comprising instructions that, when the program is executed by a data processing unit, cause the data processing unit to perform the method for operating a measuring device according to one embodiment.

### BRIEF DESCRIPTION OF THE DRAWINGS

Embodiments of the disclosure are described with reference to the following figures. The figures show:

FIG. 1 a schematic illustration of a measuring device according to one embodiment;

FIG. 2 a further schematic illustration of the measuring device according to a further embodiment;

FIG. 3 a further schematic illustration of the measuring device according to a further embodiment;

FIG. 4 a schematic illustration of a measurement of the measuring device according to one embodiment,

FIG. 5 a further schematic illustration of the measuring device according to a further embodiment;

FIG. 6 a flowchart of a method for operating a measuring device according to one embodiment,

FIG. 7 a further flowchart of the method for operating a measuring device according to a further embodiment,

FIG. 8 a further flowchart of the method for operating a measuring device according to a further embodiment, and

FIG. 9 a schematic representation of a computer program product.

### DETAILED DESCRIPTION

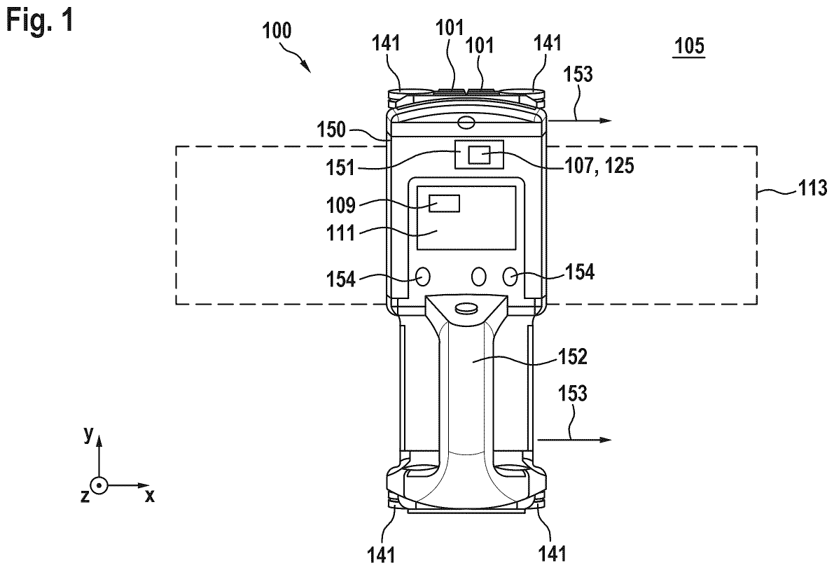

FIG. 1 shows a schematic representation of a measuring device 100 according to one embodiment.

The present disclosure relates to a measuring device, in particular to a wall diagnostic device for examining walls 105 to be processed. Wall diagnostic devices are known in the prior art that are used to detect objects disposed in walls. Such devices allow a user to examine walls to be processed to search for objects disposed in the walls in order to be able to perform planned work, for example drilling in walls, based on this such that damage to the objects disposed in the walls can be avoided.

In the embodiment shown, the measuring device 100 comprises a housing 150 having a handle 152 for grasping of the measuring device 100 by a user, a display unit 111 for displaying diagnostic results 109 of the wall diagnostics, and controls 154 for switching the measuring device 100 to various operating modes.

According to the disclosure, the measuring device 100 comprises at least one radar sensor unit 101. By means of the radar sensor unit 101, radar signals may be transmitted towards the wall 105 to be examined and radar signals reflected by the wall 105 may be received.

For example, the radar sensor unit 101 may be configured as a narrow band radar detector device in the 2.4 GHz to 2.4835 GHz frequency range or as an ultra-wide band radar detector device in the 1.8 GHz to 5.8 GHz frequency range.

The measuring device 100 further comprises a diagnostic module 107 executable on a computing unit 151 of the measuring device 100 to perform the wall diagnostics. The diagnostic module 107 is configured to perform a corresponding diagnosis of the wall to be examined based on the radar data 103 of the radar sensor unit 101. The radar data 103 of the radar sensor unit 101 thereby depicts the wall 105 to be examined and, if applicable, objects 113 disposed within the wall 105.

The wall diagnostics carried out by the diagnostic module 107 comprises at least performing an object recognition. The object recognition here comprises an object detection and an object classification of the object 113 disposed in the wall 105. The object detection comprises at least the determination of an object position 115. The object position here describes the positioning of the object disposed in the wall 105 with respect to a reference system defined by the measuring device 100. The object classification of the detected object 113 comprises at least determining an object type 117 of the detected object 113.

The diagnostic results of the wall diagnostics determined in this way, i.e. at least the determined object position 115 and/or the determined object type 117 of the object 113 disposed in the wall 105, are subsequently presented in a display unit 111 of the measuring device 100 to a user of the measuring device 100. For example, the display unit 111 may be configured as a corresponding display and the diagnostic results 109 may be visually displayed. Additionally, the display of the diagnostic results 109 may be supported via audible and/or haptic signals. For example, the haptic signals may be realized via corresponding vibration signals.

The object 113 can be shown in the display, for example, by means of a corresponding icon. The object 113 can be shown in the corresponding object position 115 in the display. The object extension 121 may be visualized by a corresponding size of the displayed icon. The particular object type 117 of the object 113 may be visualized with a corresponding term or color highlighting of the icon, or by a specific shape of the icon representing the object 113.

Alternatively, the wall diagnostics may additionally comprise determining a wall type 123 in the form of a wall type classification of the wall 105 to be examined. The wall type 123 describes the respective type of the wall 105 to be examined. For example, the wall type may be associated with corresponding wall type classes, which may comprise: Concrete wall, plasterboard/drywall wall, brick wall and/or wall bricks, underfloor heating, wall heating or similar wall types found in buildings.

According to one embodiment, the diagnostic module 107 is further configured to determine an object depth 119 of the object 113 within the wall 105 based on the radar data 103. The object depth 119 is defined by a distance of the object formed in the wall 105 to a surface of the wall 105. The distance may be defined on the object side, for example with respect to an object surface or with respect to an object center point. The distance to the surface of the wall 105 describes a shortest distance defined by a direction perpendicular to the surface of the wall 105.

According to one embodiment, the diagnostic module 107 is further configured to determine an object extension 121 of the object 113 in at least one predefined direction based on the radar data 103. The object extension 121 of the object 113 describes a spatial extension of the object 113 in at least one spatial direction, preferably in two spatial directions, particularly preferably in three spatial directions. The object 113 may be described here as a one-dimensional, two-dimensional, or three-dimensional object 113.

In conventional use, the measuring device 100 is placed on the surface of the wall 105 to be examined. Radar signals are transmitted towards the wall 105 and radar signals reflected from the wall 105 or the objects 113 disposed there are received via the radar sensor unit 101. This radar data 103 of the radar sensor unit 101 is used by the diagnostic module 107 to perform the wall diagnostics described above and to determine corresponding diagnostic results 109.

For example, the diagnostic results 109 may comprise the object position 115 and/or object type 117 of the object 113 disposed in the wall 105. Alternatively or additionally, the diagnostic results 109 may comprise the wall type 123 of the wall 105 and/or the object depth 119 and/or the object extension 121 of the object 113.

The diagnostic results 109 configured in this manner may subsequently be displayed to a user of the measuring device 100 in a display unit 111 of the measuring device 100. The display unit 111 can be configured as a corresponding display, for example. The diagnostic results 109 may be displayed in graphical or textual form in the display unit 111.

According to one embodiment, the measuring device 100 further comprises a motion detection unit 141. The motion detection unit 141 may be used to detect movement of the measuring device 100 relative to the wall 105. The motion detection unit 141 may comprise, for example, at least one roller element for this purpose. When the roller element is placed on the wall surface of the wall 105, movement of the measuring device 100 relative to the wall 105 can be detected when the measuring device 100 moves along a direction of movement 153 by rolling the roller element. Alternatively, the motion detection unit 141 may have a different configuration by which a relative movement of the measuring device 100 relative to the wall 105 can be detected.

By moving the measuring device 100 relative to the wall 105, radar data 103 of the radar sensor unit 101 may be captured for a plurality of different positions of the measuring device 100 relative to the wall 105. This allows a larger spatial area of the wall 105 to be examined than that given by the effective range of the radar sensor unit 101. This allows for objects 113 to be captured that have a greater spatial extent than the effective range of the radar sensor unit 101.

While the measuring device 100 moves along the direction of movement 153, radar data 103 of the radar sensor unit 101 may be captured continuously. The wall diagnostics may be evaluated by the diagnostic module 107 based on this radar data 103 while the measuring device 100 is moving along the direction of movement 153. This allows for accelerated wall diagnostics, taking into account the positioning of the measuring device 100 relative to the wall 105.

According to its embodiment, the diagnostic module 107 is configured as a correspondingly trained artificial intelligence 125. The artificial intelligence 125 is trained to perform the above-described wall diagnostics based on the radar data 103 of the radar sensor unit 101 and to determine at least the object position 115 and the object type 117 of an object 113 disposed in the wall 105. The object classification or determination the object type 117, respectively, comprises assigning the detected object 113 to predefined object classes.

The object classes may comprise: Metal/non-metal object, low voltage cable, single phase AC signal cable, multi-phase AC signal cable, wood beam, metal beam, plastic pipe, water filled plastic pipe, for example fresh water pipe, non-water filled plastic pipe, for example waste water pipe, or other elements commonly installed in building walls.

Further, the artificial intelligence 125 may be trained to determine the wall type 123 of the wall 105 to be examined at least based on the radar data 103 of the radar sensor unit 101. Possible wall types 123 may comprise: Concrete wall, plasterboard/drywall wall, brick wall and/or individual bricks of the brick wall, underfloor heating, wall heating or other similar wall types commonly installed in buildings.

According to one embodiment, in addition to the radar sensor unit 101, the measuring device 100 may comprise further additional sensors by means of which additional physical variables are detectable. For example, the measuring device 100 may comprise an induction sensor and/or an eddy current sensor and/or a capacitance sensor and/or an AC current sensor and/or an NMR sensor and/or an ultrasonic sensor or other sensors commonly used in wall diagnostic devices.

The diagnostic module 107, in particular the corresponding trained artificial intelligence 125, can be configured to perform wall diagnostics based on the radar data 103 of the radar sensor unit 101 and taking into account the additional sensor information of the further sensors described above. The additional information of the additional sensors mentioned above can in particular be used for object recognition of the objects 113 disposed in the walls 105. The additional sensor information may possibly provide improved detection of the objects 113 and may possibly provide improved classification of the objects 113.

In particular, for example, the material of the objects 113, for example as a metallic or non-metallic material, can be improved and classified by using the additional sensor information.

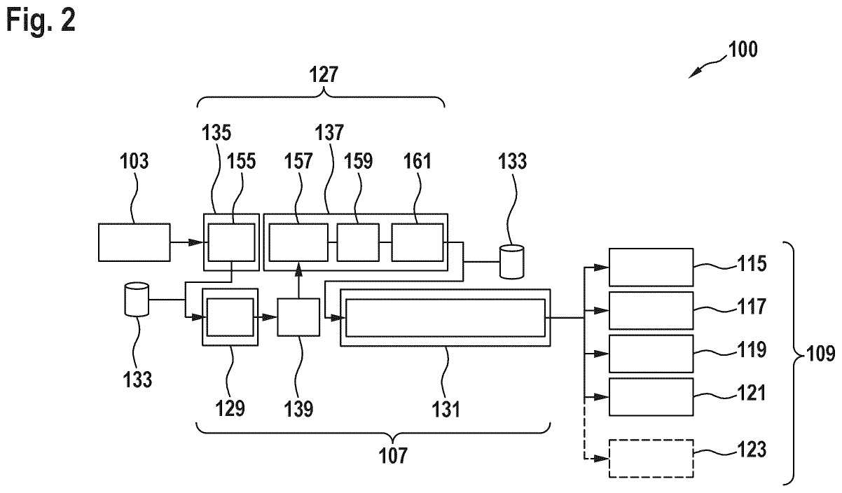

FIG. 2 shows another schematic representation of the measuring device 100 according to a further embodiment.

In the embodiment shown, the measuring device 100 comprises a pre-processing module 127 in addition to the diagnostic module 107. For wall diagnostics, the measuring device 100 first receives the radar data 103 of the radar sensor unit 101. Pre-processing of the receiving radar data 103 is performed via the pre-processing module 127. For example, via pre-processing of the pre-processing module 127, the radar data may be brought into a corresponding data structure required for wall diagnostics by the diagnostic module 107.

As described above, during wall diagnostics, the diagnostic module 107 generates the diagnostic results 109 described above. For example, the diagnostic results 109 may comprise the object position 115 and/or object type 117 and/or object depth 119 and/or object extension 121 of an object 113 formed in the wall to be examined 105 and/or the wall type 123 of the wall 105 to be examined. The correspondingly generated diagnostic results 109 may subsequently be displayed in the display unit 111 of the measuring device 100.

According to one embodiment, in addition to the radar data 103 of the radar sensor unit 101, the additional sensor information of the additional sensors described above may be included in the wall diagnostics of diagnostic module 107. A corresponding pre-processing of the additional sensor information may be performed accordingly by the pre-processing module 127.

In the embodiment shown, the diagnostic module 107 comprises a wall type classification module 129 and an object recognition module 131. The pre-processing module 127 comprises a first pre-processing module 135 and a second pre-processing module 137. The first pre-processing module 135 comprises an S matrix reduction 155. The second pre-processing module 137 comprises a background correction 157, an inverse Fast Fourier transformation 159, and a focusing and migration 161. In the pre-processing of the radar data 103 by the pre-processing module 127, the radar data 103 is first pre-processed by the first pre-processing module 135 and the S-matrix reduction 155 contained therein.

When doing so, the first pre-processing module 135 generates input data 133 based on the radar data 103. The input data 133 serves as input data for the wall type classification module 129. The wall type classification module 129 performs a wall type classification of the wall 105 to be examined based on the input data 133 and generates wall type information 139. The wall type information 139 contains the wall type 123 of the wall 105 to be examined, as determined in the wall type classification.

Subsequently, the second pre-processing module 137 performs pre-processing based on the radar data 103 and the wall type information 139. A background correction 157 of the radar data 103 is performed during this, taking into account the wall type 123 determined in the wall type information 139. Depending on the wall type 123 of the wall 105 to be examined, different effects on the radar data 103 can occur.

These effects, which are primarily based on the respective wall type 123 and can affect object recognition, can be corrected by the background correction 157. After the background correction has been performed, further pre-processing can be carried out by performing the inverse Fast Fourier transformation 159 or focusing and migration 161, respectively, and input data 133 can be created for the object recognition module 131 once again. Based on the input data 133 provided by the second pre-processing module 137, the object recognition module 133 performs the object recognition of the object 113 disposed in the wall 105 to be examined and determines at least the object position 115 and the object type 117 of the respective object 113. Additionally, the object depth 119 and the object extension 121 may be determined by the object recognition module 131.

According to one embodiment, the diagnostic module is further configured to determine an object depth of the object within the wall based on the radar data, wherein the object depth is defined by a distance of the object formed in the wall to a surface of the wall.

The pre-processing is optional. Depending on the algorithm used for the diagnostic module 107, completely unprocessed radar echoes of different frequencies may be used as radar data 103 and as input data for the diagnostic module 107. Alternatively, radar data 103 processed via multiple steps may be used. The pre-processing steps comprise, for example, the transformation of the signals from the frequency domain to the time or distance domain, background deduction, noise removal, and normalization of the signals. For radar data 103 which is available in the form of complex numbers, only the absolute value can be processed. Alternatively or additionally, the phase information may be considered.

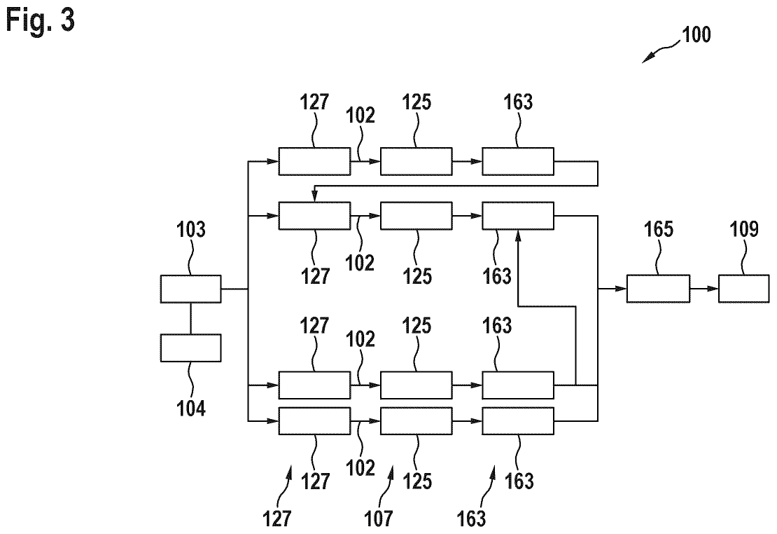

FIG. 3 shows a further schematic representation of the measuring device 100 according to a further embodiment.

In the embodiment shown, the diagnostic module 107 comprises a plurality of parallel processing paths 102. Each processing path 102 includes a pre-processing module 127, the diagnostic module 107, for example, comprising the wall type classification module 129 and/or the object recognition module 131 according to the embodiment in FIG. 2, and a post-processing module 163.

In FIG. 3, primarily the radar data 103 is shown as input data for the wall diagnostics. In addition to the radar data shown, however, the additional information of the additional sensors may also serve as input data for the wall diagnostics. Here, the different information from the different types of sensors in the different parallel processing paths 102 can be processed and the corresponding wall diagnostics performed separately on the different sensor information. Upon completion of the wall diagnostics, a summary module may be used to assemble a summary of the individual sub-analysis results to form the diagnostic results 109 of the wall diagnostics.

Alternatively or additionally, different sub-aspects of the wall diagnostics may be performed by the different processing paths 102 based on the same sensor information.

For example, the individual processing paths 102 may process different radar data 103 captured during movement of the measuring device 100 relative to the wall 105 for different positions of the measuring device 100 relative to the wall 105. The radar data 103, thus representing different regions of the wall 105 and captured sequentially in time as the measuring device 100 moved relative to the wall 105, may then be processed in the different processing paths 102 by the modules shown.

The different processing paths perform a stand-alone wall diagnostics in this respect, comprising at least determining the object position 115 and/or the object type 117 of the object 113 disposed in the wall 105.

The summary module 165 may summarize the sub-results provided in the individual processing paths 102 of the stand-alone wall diagnostics of the different regions of the wall 105 into a contiguous diagnostic result 109. The contiguous diagnostic result here describes the wall diagnostics of a contiguous spatial area that was covered during movement of the measuring device 100 relative to the wall 105 and depicted by the corresponding captured radar data 103. The parallel processing of the radar data 103 or additional sensor information 104 of the additional sensor elements in the different processing paths 102 thus enables accelerated wall diagnostics.

Alternatively, various wall diagnostic functions may also be performed in the different processing paths 102. For example, in one processing path 102, the wall type classification and the determination of the wall type 123 of the wall 105 to be examined can be performed. In another processing path 102, object recognition of the object disposed in the wall 113 can be performed. The object detection can be performed with the determination of the object position 115 and the object classification can be performed with the determination of the object type 113 in one processing path 102.

Alternatively, the object detection and object classification may then also be performed in two separate processing paths 102. In further processing paths 102, the object depth determination, i.e., the determination of the object depth 119 and/or the determination of the object extension 121 may respectively be carried out. In the summary module 165, the various sub-results of the wall diagnostics may be summarized into corresponding diagnostic results 109.

The diagnostic module 107 can be divided into different artificial intelligences 125, as already shown in the embodiment in FIG. 2. For example, the diagnostic module 107 may comprise a wall type classification module 129 and an object recognition module 131. The object recognition module may in turn be divided into an object detection module and an object classification module. The diagnostic module 107 may further comprise an object depth determination module and object extension module, respectively configured to determine the object depth 119 and the object extension 121.

The respective modules may each be configured as stand-alone artificial intelligences 125, for example, neural networks. Alternatively, the various modules may form portions of an overall artificial neural network that are connected to an overall neural network according to structures known in the prior art.

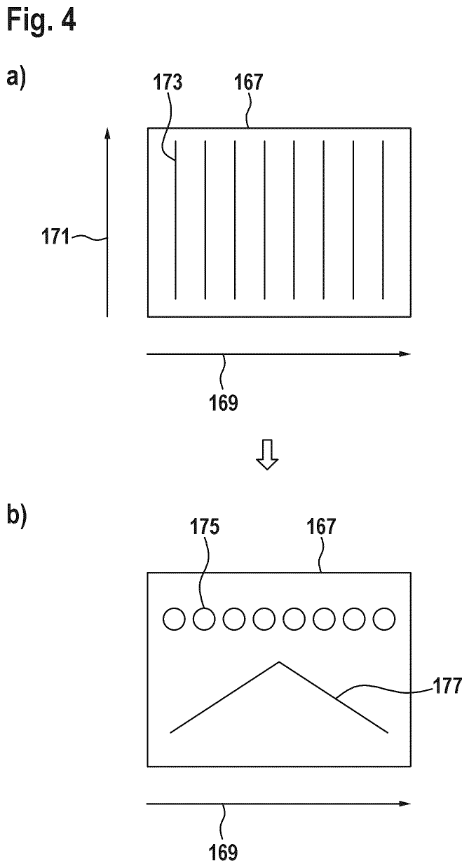

FIG. 4 shows a schematic illustration of a measurement of the measuring device 100 according to one embodiment.

For pre-processing, the radar data 103 or the additional sensor information 104 of the remaining sensors may be normalized, in particular to numerically stabilize the subsequent steps performed by the diagnostic module 107 during wall diagnostics. For example, an amplitude and/or offset compensation may be performed for this purpose. Further, to reduce interference, filtering of the radar data 103 may be carried out, and to reduce the data rate the corresponding sensor data may be sampled. Further, the radar data 103 or the additional sensor information 104 may be transformed to the respective required frequency range or time range. Methods known from the prior art can be used for this purpose.

Further, the captured radar data 103 or additional sensor information 104 may be divided into temporal or spatial windows 167. Temporal windows 167 may be generated by recording the radar data 103 or the additional sensor information or the pre-processed radar data 103 over a fixed time interval. Spatial windows 167, on the other hand, may be generated from a mapping of the radar data 103 or additional sensor information 104 to positions of the measuring device 100 relative to the wall 105 along the direction of movement 153.

Graph a) of FIG. 4 shows such a data matrix resulting from the steps described above. The data matrix of the window 167 shown in graph a) shows a plurality of sensor data, which may comprise, for example, radar data 103 or additional sensor information 104 of the further sensors plotted along a frequency channel axis 171 or along a space/time axis 169, respectively.

A width of the temporal windows 167 may be selected such that different sampling rates of the sensors may be balanced and a new window 167 may be provided frequently enough so that a display of the diagnostic results 109 of the wall diagnostics in the display unit 111 may be shown without too great of a time delay while the measurement is being performed or shortly after the measurement of the measuring device 100 ends.

A rate of 2 to 20 windows per second of the data recording of the sensor data may be advantageous for this purpose. For spatial windows, the spatial sampling rates can be selected to achieve the desired local accuracy. Advantageously, 1 mm to 1 cm sampling rates can be used. This means that corresponding sensor data is captured every 1 mm to 1 cm of movement of the measuring device 100 along the direction of movement 153.

A width of the spatial windows 167 may be selected such that contiguous information relating to an object 113 is contained in a window. Advantageously, a width of the respective spatial windows 167 can be 1 cm to 20 cm. This results in 4 to 100 measured values per window 167. This allows for further efficient algorithmic processing of the correspondingly recorded radar data 103 or additional sensor information by the diagnostic module 107.

A further temporal window 167 or spatial window 167 can be provided as soon as one or more scan points are available.

The diagnostic module 107 may be oriented such that a matrix corresponding to the window size of the respective spatial or temporal window 167 may be included as input data, for example of each processing path 102 of the embodiment in FIG. 3 as well. According to the embodiment of FIG. 2, the corresponding input data can comprise the respective pre-processed sensor data, i.e. radar data 103 and additional sensor information 104 of the additional sensors.

As stated above, wall diagnostics may be performed by the diagnostic module 107 based on a correspondingly trained artificial intelligence. Alternatively, different processing paths may also be calculated by rule-based algorithms. A combination of artificial intelligence and a rule-based algorithm is also possible within a processing path 102 in the form of a parallel connection or concatenation.

The diagnostic results 109 of the wall diagnostics may be implemented as numeric values, vectors, or matrices. Further, the probability of detection, or for the wall type classification and/or the object classification, respectively, a probability of the specified object classes and/or wall type classifications can be given for the object detection. The same may apply to the position and/or depth determination, for which corresponding probability values can also be given.

If, in addition to the radar data 103, the additional sensor information of the further sensor types is processed in a processing path 102, these may either be merged within the artificial intelligence 125 or combined by rule-based combinations.

In the post-processing of each processing path 102, of the embodiment of FIG. 3, multiple algorithm results based on multiple windows 167 may be summarized by the summary module 165. This summary can in particular be realized by majority formation, sum formation or also by multiplication of successive probability values.

Further, by clustering multiple results, for example, it is possible to detect which objects of multiple detected objects lying close to one another are the same object so that they are not incorrectly detected multiple times.

Likewise, it is possible to multiply a weighting function 177 when summarizing the results from multiple windows 167. Advantageously, the diagnostic sub-results 175 corresponding to corresponding data points in the space may be weighted with respect to positioning of the diagnostic sub-results 175 relative to a center point of the respective window 167. This is illustrated by way of example in graph b), in which the individual diagnostic sub-results 175 are weighted according to the weighting function 177 shown with respect to the center point of the window 167 shown.

According to one embodiment, the results of one processing path 102 after post-processing 163 may influence the extension of another processing path 102. Here, weighting parameters may be adjusted that may depend on the particular result from the processing path 102 for each window.

For example, the result of an object classification in which the object type 117 of an object disposed in the wall 105 is defined can be utilized to increase the weight of a wall type classification in which the wall type 123 of the respective wall 105 is determined in the post-processing at locations without objects 113, because the respective radar data 103 at these locations are less influenced by reflections of the objects 113.

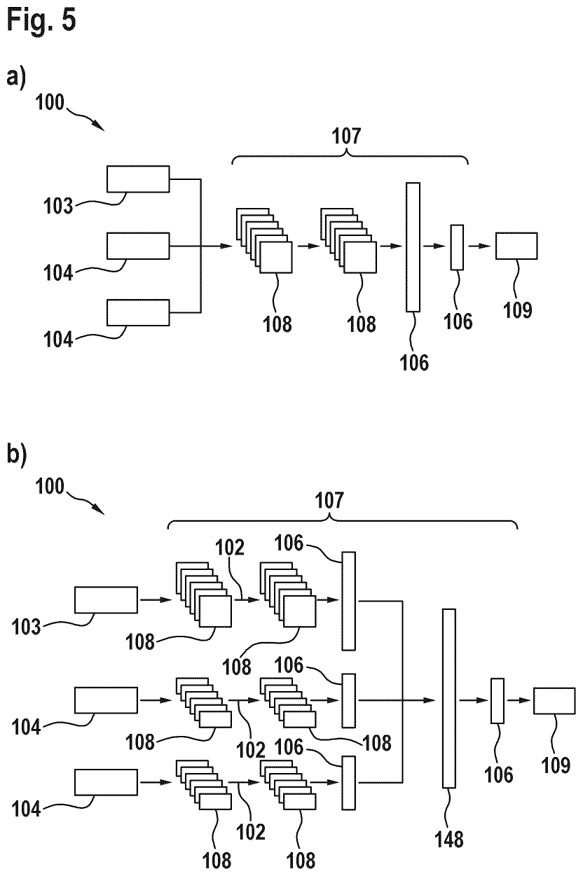

FIG. 5 shows a further schematic representation of the measuring device 100 according to a further embodiment.

Graphs a) and b) of FIG. 5 show two different alternatives of a joint data processing of radar data 103 and additional sensor information 104 by the diagnostic module 107.

Graph b) illustrates a joint processing of the radar data 103 and the additional sensor information 104 of the additional sensors by the diagnostic module 107. For this purpose, the radar data 103 and the additional sensor information 104 are collectively used as input data of the diagnostic module 107 configured as an artificial intelligence, in particular as an artificial neural network. The diagnostic module 107 here comprises multiple convolutions 108 and multiple dense layers 106. The radar data 103 and the additional sensor information 104 are processed jointly as input data via the convolutions 108 and dense layers 106. The aforementioned diagnostic results 109 are created as output data of the diagnostic module 107, based on this.

In graph b), in contrast, the radar data 103 and the additional sensor information 104 are used as stand-alone input data of the diagnostic module 107. The diagnostic module 107 becomes multiple processing paths 102. The processing paths 102 each comprise multiple convolutions 108 and at least one dense layer 106. In the various processing paths 102, wall diagnostics are performed separately by the diagnostic module 107 based on the radar data 103 and the additional sensor information 104, respectively.

In an additional concatenation layer 148, the partial results of the partial diagnoses of the different processing paths 102 are combined and fed to a final dense layer 106. The output data of the diagnostic module 107 corresponds to the diagnostic results 109 described above.

The correspondingly configured diagnostic module 107 is designed to perform wall diagnostics as described above, including the features described above, based on the radar data 103 and the additional sensor information 104.

In the embodiment shown, the diagnostic module 107 is configured as an artificial neural network, in particular as a convolutional network. Corresponding network architectures with convolutions 108, dense layers 106, and concatenation layers 148 are known from the prior art.

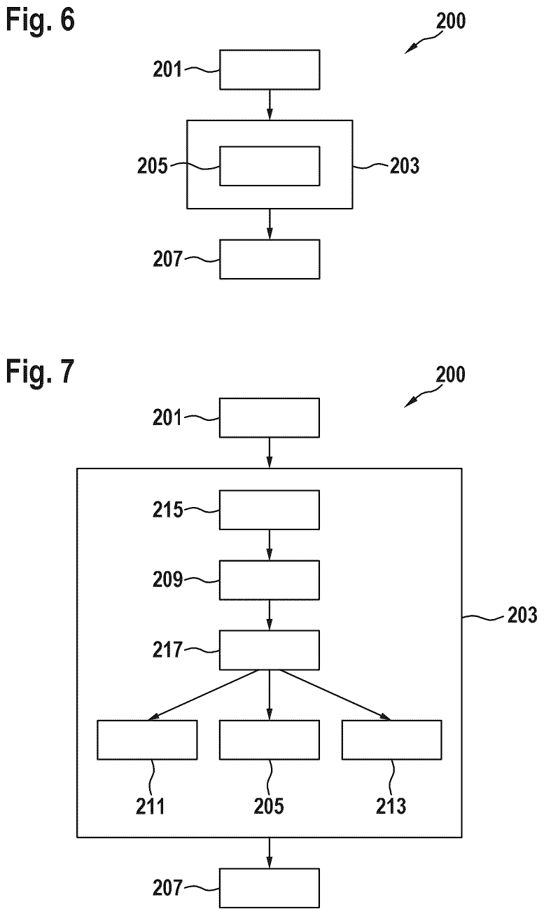

FIG. 6 shows a flowchart of a method 200 for operating a measuring device 100 according to one embodiment.

To operate the measuring device 100, in a first method step 201, radar data 103 of a radar sensor unit 101 of the measuring device 100 is first received. The radar data 103 here depicts a wall 105 to be diagnosed. Additionally, additional sensor information 104 may be received from additional sensors of the measuring device 100.

In a subsequent method step 203, the wall diagnostics are performed by the diagnostic module 107 of the measuring device 100 based on the radar data 103 and the additional sensor data 104. The diagnostic module 107 analyzes the radar data 103 and additional sensor information 104, and provides corresponding diagnostic results 109.

For this purpose, in a further method step 205, the diagnostic module 107 performs an object recognition of an object located in the wall 105. The object recognition comprises an object detection, in which an object position 115 of the object 113 is determined in the wall 105, and an object classification, in which an object type 117 of the object 113 is determined.

In a further method step 207, the diagnostic results 109 of the wall diagnostics are displayed in a display unit 111 of the measuring device 100. The diagnostic results 109 comprise at least the object position 115 in the wall 105 and the object type 117 of the object 113.

FIG. 7 shows a further flowchart of the method 200 for operating a measuring device 100 according to a further embodiment.

The embodiment shown is based on the embodiment of FIG. 6 and comprises all the features described therein.

In the embodiment shown, the method step 203 first comprises a method step 215. In method step 215, a first pre-processing module 135 pre-processes the radar data 103 or the additional sensor information 104, respectively, and provides input data 133 to a wall type classification module 129. For this purpose, the first pre-processing module 135 according to the embodiment in FIG. 2 may execute an S-matrix reduction 155.

In a method step 209, a wall type classification is performed by the wall type classification module 129 based on the input data 133 and a wall type 123 of the wall 105 being examined is determined.

Further, the wall type classification module 129 provides wall type information 139 comprising the previously determined wall type 123 of wall 105.

In a further method step 217, a second pre-processing module 137 performs pre-processing of the radar data 103 or additional sensor information 104, taking into account the wall type information 139 provided by the wall type classification module 129. For this purpose, according to the embodiment in FIG. 2, the second pre-processing module may perform a background correction 157 of the radar data 103 or additional sensor information 104, taking into account the wall type information 139. In the background correction, the information on the wall type 123 of the wall is used to correct the radar data 103 or additional sensor information 104, respectively.

Depending on the wall type 123 of the wall to be examined, deviations in the received radar data 103 or sensor information 104 may occur. These may be corrected in consideration of the present wall type 123 such that the corrected radar data 103 or additional sensor information 104 provides wall-type independent information.

Further, an inverse Fast Fourier transformation 159 of the wall type corrected data may be performed by the second pre-processing module 137. Additionally, focusing and migration 161 may be performed. Based on this, input data 133 is provided to an object detection module 131 by the second pre-processing module 137.

In method step 205, the object detection module 131 performs an object recognition of the object 113 disposed in the wall 105 based on the input data 133, including object detection and object classification.

Further, in a method step 211, an object depth determination of an object depth 119 of the object 113 may be performed in the wall 105. This may in turn be determined by the correspondingly configured object recognition module 131. The object depth describes a section of the object 113 towards a surface of the wall 105.

Further, in a method step 213, an object extension 121 of the object 113 may be determined along a predefined direction using the object detection module 131.

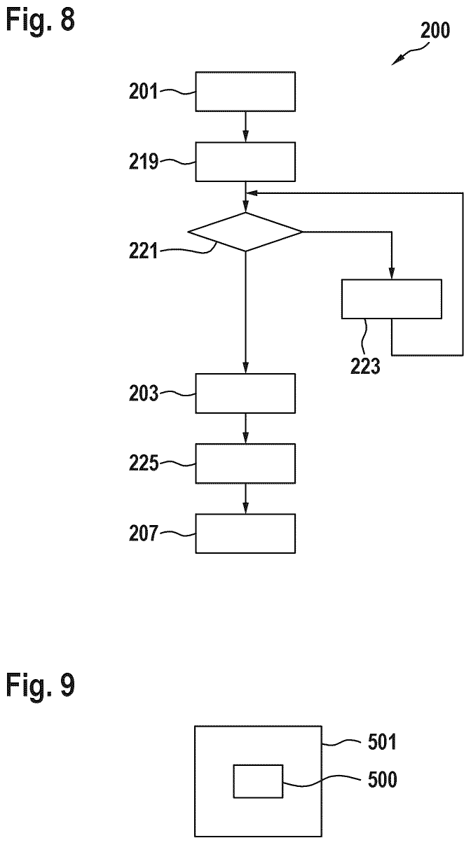

FIG. 8 shows a further flowchart of the method 200 for operating a measuring device 100 according to a further embodiment.

The embodiment shown is based on the embodiments of FIG. 6, 7 and comprises all the features described therein.

In the embodiment shown, in a method step 219, movement data of a motion detection unit 141 of the measuring device 100 is first received. The movement data here depicts a movement of the measuring device 100 relative to the wall 105 between a plurality of positions of the measuring device 100 relative to the wall 105.

In a further method step 221, based on the movement data of the movement detection unit 141, a check is carried out to determine whether a movement of the measuring device 100 relative to the wall 105 has been detected over a predefined distance.

If no such movement of the measuring device 100 relative to the wall 105 has been detected, then in a method step 223, the radar data 103 or the additional sensor information 104 stored in a time period between a previous check and the most recent check is stored. Further, the movement is checked once again.

If such movement of the measuring device 100 relative to the wall 105 has been detected over the predefined distance, the wall diagnostics are performed by the diagnostic module 107, according to the embodiments described above, based on the radar data 103 and the additional sensor information 104, respectively. The wall diagnostics are performed while the measuring device is moving 100 relative to the wall. Here, the wall diagnostics are divided into several successively performed sections, and partial results of the wall diagnostics are determined in the different sections. The partial results here describe partial objects that are detected during object recognition by the diagnostic module 107.

For example, the sub-objects may include sub-sections of a contiguous object 113, as the measuring device 100 performs the scan during its movement relative to the wall 105. The sections of the contiguous object 113 represented by the sub-objects result from the predefined distances traveled by the measuring device 100 while it moves relative to the wall 105.

In a further method step 225, the sub-objects detected during the wall diagnostics are summarized into a contiguous object 113. Summarizing or assembling the sub-objects into the contiguous object 113 occurs primarily if there is a predefined distance dependency between the sub-objects. The distance dependency describes that the sub-objects are respective parts of the contiguous object 113.

The summarizing of the partial results may also refer to the separate processing in processing paths 102 according to the embodiments of FIGS. 3 and 5, in which the radar data 103 and the additional sensor information 104 are processed separately in processing paths 102 configured independently from each other. The partial results produced in the processing paths 102 are subsequently summarized into the overall result.

Furthermore, the partial results may be related to the various aspects of wall diagnosis. Thus, the object position 115, object type 117, object depth 119, and/or object extension 121, as described in the embodiment of FIG. 3, may be determined in different processing paths 102 as stand-alone sub-results. In the summary, the various sub-results may be merged into an overall result that a contiguous object 113 of a determined object type 117 and a determined object extension 121 is located at a determined object depth 119 at an object position 115 in the wall 105.

As described above, the wall diagnostics can be performed by the measurement device 100 based on windows 167 of the radar data 103 and additional sensor information 104. The windows 167 describe a spatial area of the wall 105 to be examined, which is recorded by the measurement device 100 in a specific position relative to the wall 105 by capturing radar data 103 or additional sensor information 104. As the measurement device 100 moves relative to the wall, multiple windows 167 are captured in succession, which may overlap and which contiguously depict a spatial area of the wall 105 that was covered by the movement of the measurement device 100 relative to the wall 105.

By combining the various windows 167, the contiguous spatial area can be examined through wall diagnostics, and an object 113 located in the spatial area can be detected and classified as a contiguous object. The merging of multiple windows 167 can occur, for example, through clustering at multiple measurement points. The measurement points describe positions of the measurement device 100 relative to the wall where radar data 103 or additional sensor information 104 was recorded.

The windows 167 are then merged through clustering if the measurement points at which the respective windows 167 were captured are considered contiguous due to a predetermined geometric distance between the measurement points. This summarizing or merging can also be understood as grouping. An object 113 can be detected in each of the individual windows 167, if such an object 113 is present. Alternatively, no such object 113 is detected in a window 167. Upon detection of an object 113, the object position 115, the respective object type 117, the object depth 119, and/or the object extension 121 are subsequently determined.

An extended object 113 disposed in the wall 105 is traversed by movement of the measuring device 100 relative to the wall 105, and corresponding data is collected. This allows the object 113 to be sampled from different viewing directions. As a result, data variance may be increased, and more robust object detection may be achieved.

According to one embodiment, the diagnostic module 107 is configured as a correspondingly trained artificial intelligence, which is designed to perform the above-described wall diagnostics. Training of the artificial intelligence can be carried out in accordance with training methods known from the prior art.

The training datasets used for the training may comprise radar data 103 and optionally additional sensor information 104, each representing walls 105 of different wall types 123 with different objects 113 arranged in the walls 105 of different object types 117. These objects are each positioned at different object positions 115 at different object depths 119 in the walls 105 and have different object extensions 121.

The corresponding data of the training datasets are labeled by a characteristic labeling method, whereby the respective data is classified with respect to the respective wall type 123, the presence of an object 113, an object position 115, an object type 117, an object depth 119, and/or an object extension 121. For example, the respective radar data 103 or additional sensor information 104 may be based on actual measurements of a corresponding measuring device 100 from real walls 105.

For the purpose of generating training datasets, corresponding measuring devices 100 may be used to collect relevant datasets from real walls 105 with real objects 113 arranged in them. Alternatively or additionally, the data of the training datasets may include laboratory data that simulates, for example, only corresponding radar data 103 or additional sensor information 104 of walls 105 with objects 113.

Alternatively or additionally, the data of the training data sets may be based on measurements from measuring devices 100 taken on pre-prepared laboratory walls, wherein the object positions 115 in the laboratory walls, object types 117, object depths 119, and/or object extensions 121 of the objects 113 disposed in the walls 105, as well as the wall types 123 of the walls 105 are known.

The training of the artificial intelligence 125 may be configured to perform object recognition, including object detection and object classification of the objects 113. The artificial intelligence 125 can be further trained to determine the wall type 123. The artificial intelligence 125 can be further trained to determine the object depth 119. The artificial intelligence can be further trained to determine the object extension 121.

Alternatively, the diagnostic module 107 may comprise multiple artificial intelligences 125, each trained to perform the object recognition, wall type classification, object depth determination, or object extension determination.

FIG. 9 shows a schematic representation of a computer program product 500 comprising instructions that, when the program is executed by a data processing unit, cause the latter to perform the method 200 for operating a measuring device 100.

In the embodiment shown, the computer program product 500 is stored on a storage medium 501. The storage medium 501 can in this case be any desired storage medium known from the prior art.

1. A computer-implemented method of operating a measuring device configured as a wall diagnostic device, comprising:
receiving radar data of a radar sensor unit of the wall diagnostic device, the radar data depicting a wall to be diagnosed;
performing wall diagnostics by performing an analysis of the radar data and providing diagnostic results with a diagnostic module of the measuring device, the wall diagnostics comprising:
performing an object recognition of an object disposed in the wall using the diagnostic module, the object recognition including object detection and object classification; and
providing the diagnostic results from the diagnostic module to a display unit of the measuring device for displaying the diagnostic results to a user of the measuring device, the diagnostic results including at least one object position in the wall and an object type of the object.

2. The method according to claim 1, the performing of the wall diagnostics further comprising:
performing a wall type classification and determining a wall type of the wall using the diagnostic module.

3. The method according to claim 1, the performing of the wall diagnostics further comprising:
performing an object depth determination and determining an object depth of the object in the wall using the diagnostic module,
wherein the object depth is defined as a distance of the object to a surface of the wall.

4. The method according to claim 1, the analysis of the radar data further comprising:
performing an object extension determination and determining an object extension of the object along a predefined direction using the diagnostic module.

5. The method according to claim 1, the performing of the wall diagnostics further comprising:
performing a pre-processing of radar data of the radar sensor unit and providing input data to a wall type classification module of the diagnostic module using a first pre-processing module;
performing the wall type classification based on the input data provided by the first pre-processing module and providing wall type information using a wall type classification module of the diagnostic module;
performing pre-processing of the radar data and providing input data to an object recognition module of the diagnostic module, taking into account the wall type information using a second pre-processing module of the diagnostic module; and
performing the object recognition based on the input data provided by the second pre-processing module and providing diagnostic results using the object detection module.

6. The method according to claim 1, wherein:
the receiving of the radar data includes receiving the radar data from a plurality of positions of the measuring device relative to the wall, and
the method further comprises receiving movement data of a movement detection unit of the measuring device, the movement data representing a movement of the measuring device relative to the wall between the plurality of positions of the measuring device relative to the wall.

7. The method according to claim 6, further comprising:
checking, based on the movement data of the movement detection unit, whether a movement of the measuring device relative to the wall by a predefined distance has been detected;
when the movement is not detected, storing the radar data and performing the check again;
when the movement by the predefined distance is detected, performing the wall diagnostics based on the radar data using the diagnostic module.

8. The method according to claim 1, the performing of the wall diagnostics further comprising:
summarizing sub-objects detected and classified at various positions of the measuring device relative to the wall, based on radar data to a contiguous object, when there is a predefined distance dependency between the sub-objects.

9. The method according to claim 1, wherein:
the measuring device further comprises at least one of an induction sensor, an eddy current sensor, a capacitance sensor, an AC current sensor, a nuclear magnetic resonance (NMR) sensor, and an ultrasonic sensor configured to provide additional sensor data, and
the diagnostic module is configured to perform the wall diagnostics by taking into account the additional sensor data.

10. The method according to claim 1, wherein the diagnostic module comprises at least one correspondingly trained artificial intelligence configured to perform at least part of the wall diagnostics based on the radar data and/or additional sensor data.

11. A computing unit comprising:
a computer program including instructions that, when executed by a data processing unit, cause the wall diagnostic device to perform the method of claim 1.

12. A computer program product comprising instructions which, when the program is executed by a data processing unit, cause the data processing unit to perform the method for operating the wall diagnostic device according to claim 1.
